(19) United States
(12) Patent Application Publication
(10) Pub. No.: US 2026/0061640 A1
(43) Pub. Date: Mar. 5, 2026

(54) SPEED-CONTROL KNIFE STRUCTURE WITH STRAIGHT IN-AND-OUT MOTION

(71) Applicant: Xing Lee, Taichung City (TW)

(72) Inventor: Xing Lee, Taichung City (TW)

(21) Appl. No.: 18/820,270

(22) Filed: Aug. 30, 2024

(51) Int. Cl. B26B 1/08

(52) U.S. Cl. CPC B26B 1/08

(57) ABSTRACT

The present invention relates to a speed-control knife structure with straight in-and-out motion, which includes a housing, an inner blade holder, an upper guide plate, a knife assembly, a push control member, two push blocks, and a trigger clip. Users can control the blade extension by applying controlled force with their hand. As long as the hand continues to apply force to the control part, the timing of the blade's extension can be managed. When no force is applied, the elastic force generated by pulling the elastic member can instantly pulls the push block located far from the blade exit, and the push block then pushes the sliding block. This allows the blade to quickly protrude from the blade exit to deter or react immediately, thereby enhancing personal safety.

### BACKGROUND OF THE INVENTION

### Fields of the invention

The present invention relates to a speed-control knife structure with straight in-and-out motion, particularly applied in the field of bladed tools.

### Descriptions of Related Art

Referring to Taiwan Patent No. 268338 titled “Knife”, this type of knife is a commonly available folding knife. However, with the advancement of technology and the progression of time, a significant issue has emerged with this type of folding knife: it cannot be deployed quickly enough. When faced with danger, one has to pinch the blade with fingers and rotate it relative to the handle pivot. The time required for this operation leaves no buffer for reaction in dangerous situations. As a result, businesses in related industries have improved upon this folding mechanism by shifting to a spring-loaded type (where the blade pops out with a press), as detailed in Taiwan Patent No. M628447 titled “Folding Knife with Elastic Rod”. However, this type of knife can pose a danger due to accidental activation. Consequently, to address this issue, a new type of folding knife has been developed that primarily features a straight extension and retraction mechanism (e.g., utility knives, switchblades). This knife with straight in-and-out motion can reduce the reaction time for extending the blade, thereby effectively enhancing personal safety. However, such knives are subject to various laws, regulations, and ownership restrictions, which hinder users' ability to deploy the blade in a timely manner for self-defense, as they may not be able to properly evaluate the level of danger. This leads to accidental injuries to the user or others.

### SUMMARY OF THE INVENTION

The primary objective of the present invention is to provide users with the ability to display an intention to deploy the knife before the blade is extended, allowing others to recognize this intention, thus giving defenders time to protect themselves. This improvement addresses the issues found in conventional knives with straight in-and-out motion, which can easily spring out and injure the user, and where defenders cannot predict or determine if the holder intends to deploy the blade.

To achieve the above objectives and effects, the present invention provides a speed-control knife structure with straight in-and-out motion, which includes: a housing, having an internal space in an interior thereof, a cutout on an end face of the housing and a blade exit on a side of the housing, wherein the internal space communicates with the cutout and the blade exit; an inner blade holder, installed in the internal space, wherein the inner blade holder has both ends assembled to the housing and is provided with a track hole extending from a top end to a bottom end of the inner blade holder; an upper guide plate, installed in the internal space and spaced from the track hole of the inner blade holder, wherein the upper guide plate is cut with a slide channel that corresponds to and communicates with the cutout and includes a control part that corresponds to the cutout and partially extends out of the cutout and becomes exposed from the housing; a knife assembly, including a blade and a sliding block, wherein (i) a part of the sliding block is slidably disposed in the track hole, while another part of the sliding block protrudes out of the track hole toward the upper guide plate, (ii) the blade is disposed on one side of the inner blade holder and opposite to the part of the sliding block that protrudes, (iii) the blade has one end assembled to the sliding block and the other end facing the blade exit, and (iv) the sliding block is movable along a profile of the track hole to drive operable extension and retraction of the blade through the blade exit; a push control member, having a part disposed in the internal space and another part protruding from the housing, wherein the push control member is located between the upper guide plate and the sliding block, allowing an axle pin to penetrate through the blade, the sliding block and the push control member, and when the upper guide plate moves toward the blade exit, the upper guide plate contacts the part of the push control member protruding from the housing during the movement, indirectly driving movement of the sliding block along the track hole; two push blocks, each detachably interlocked to the upper guide plate, located between both ends of the slide channel, and having a part interlocked within the slide channel and another part protruding downward from the upper guide plate into a gap between the upper guide plate and the inner blade holder, wherein an elastic member is installed within the slide channel and has both ends hooked onto the two push blocks, respectively; and a trigger clip, disposed between the sliding block and the upper guide plate, allowing an axle rod to penetrate through the blade, the sliding block and the trigger clip, wherein the trigger clip is configured to pivot relative to the axle rod and has a part interlocked to an end of the track hole when the blade has not yet moved toward the blade exit.

### BRIEF DESCRIPTION OF THE DRAWINGS

FIG. 1 is a perspective schematic view of the present invention.

FIG. 2 is another perspective schematic view of the present invention from a different angle.

FIG. 3 is an exploded perspective schematic view of the present invention.

FIG. 4 is a further partially exploded perspective schematic view of FIG. 3.

FIG. 5 is an action schematic view illustrating that switching the control member in the present invention causes the upper guide plate to move toward the blade exit.

FIG. 6 is an action schematic view illustrating that switching the control member in the present invention causes the actuating block of the upper guide plate to push against the push control member.

FIG. 7 is an action schematic view illustrating that switching the control member in the present invention causes the upper guide plate to push one push block and pull the elastic member, resulting in movement of the actuating rod of the positioning arm from the tilted guiding surface to the peripheral surface of the upper guide plate.

FIG. 8 is an action schematic view illustrating that switching the control member in the present invention causes the other push block to be pulled by the elastic force of the elastic member and strike the knife assembly, resulting in the trigger clip pivoting and disengaging from the curved locking section of the track hole.

FIG. 9 is an action schematic view illustrating that the displacement of the upper guide plate causes the positioning arm to latch onto the sliding block in the knife assembly.

FIG. 10 is an action schematic view illustrating that the knife assembly of the present invention is fully sprung out and locked in position.

### DETAILED DESCRIPTION OF THE PREFERRED EMBODIMENT

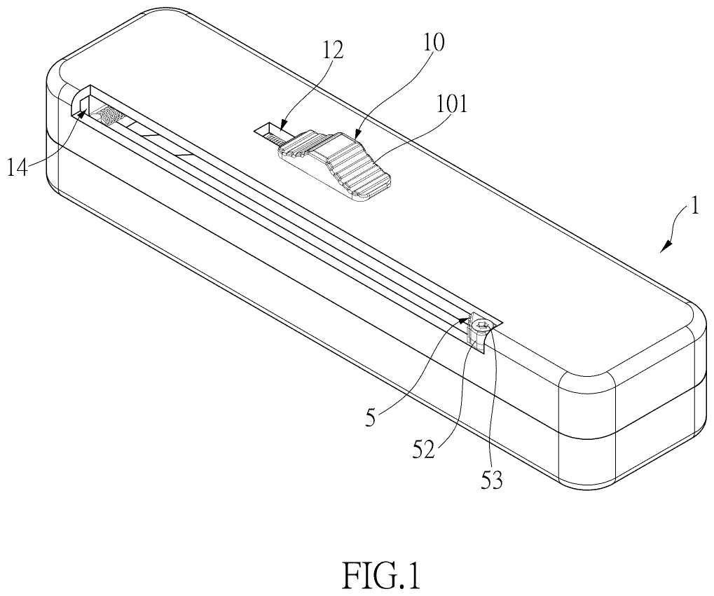

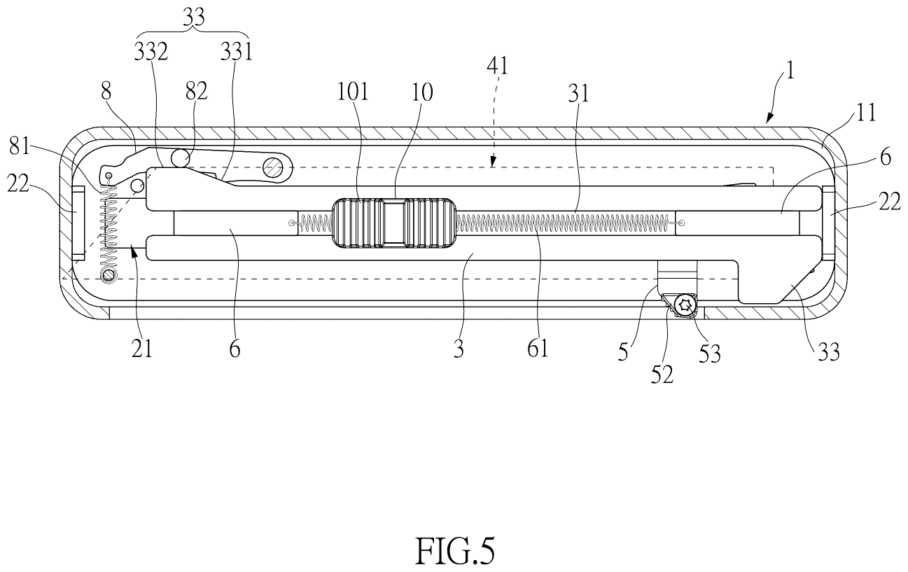

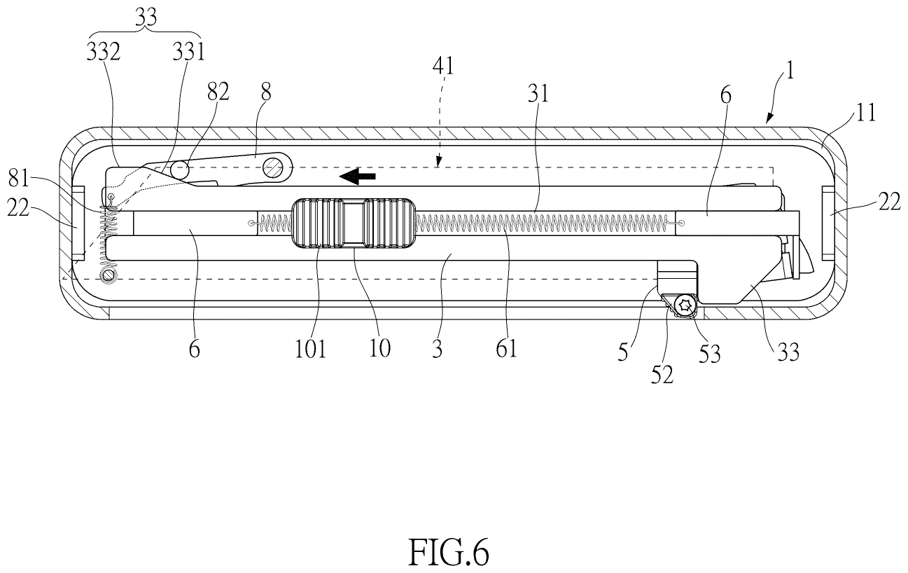

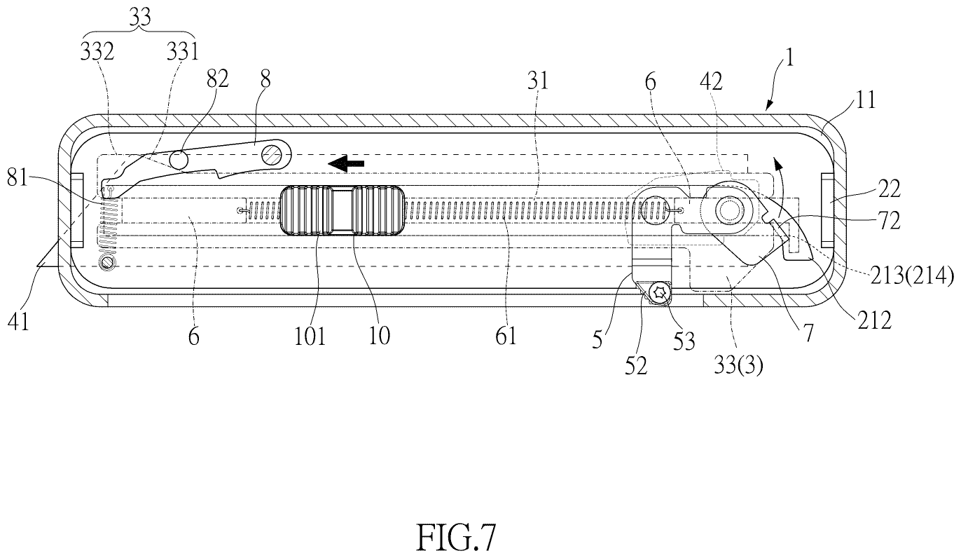

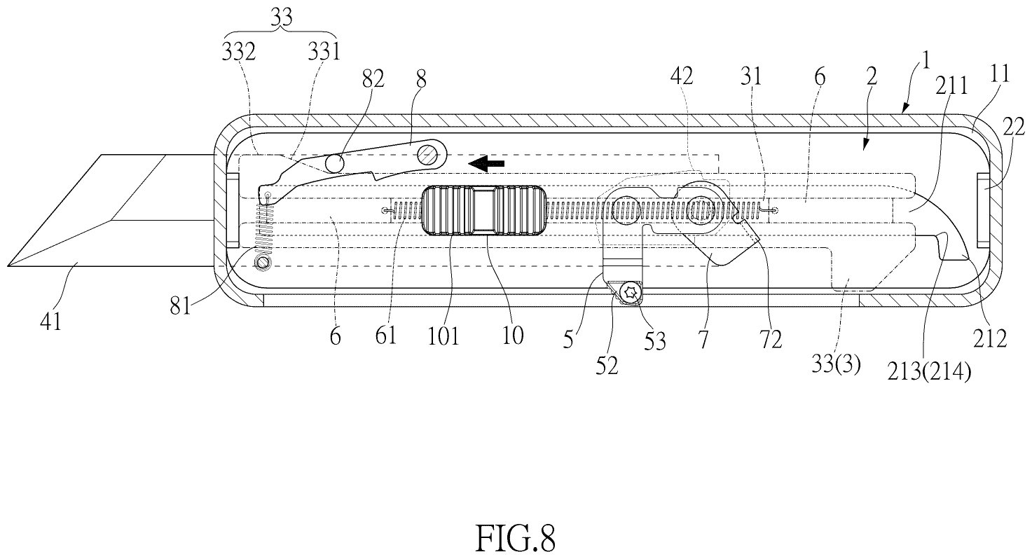

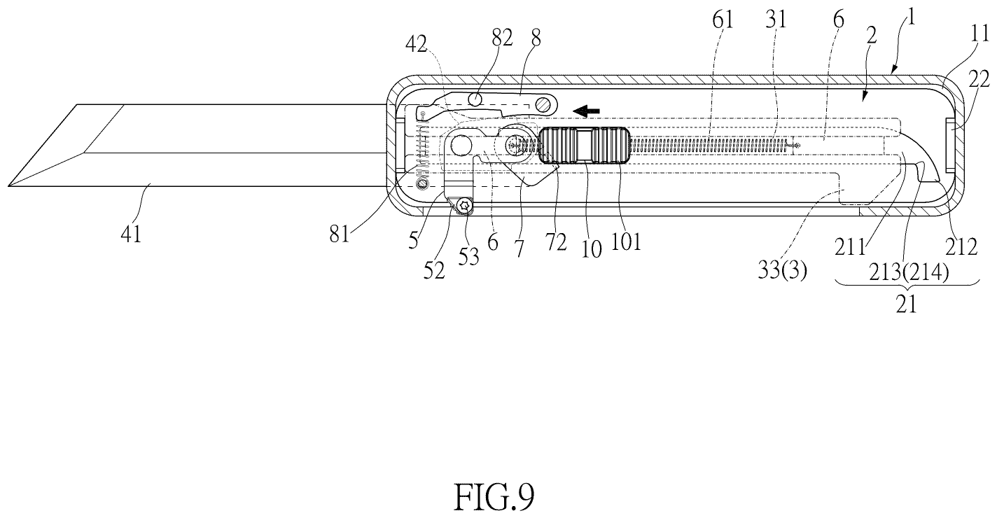

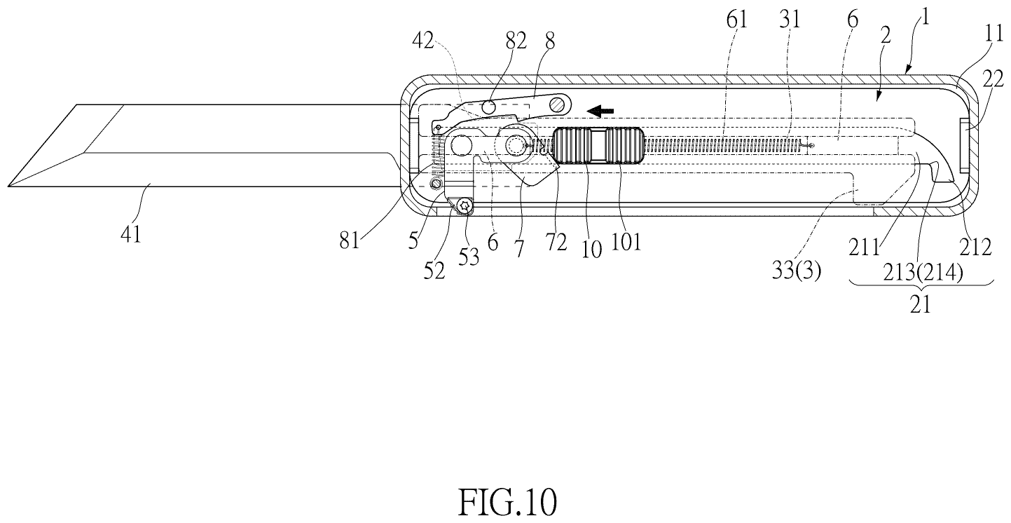

Please refer to FIGS. 1 through 10, where FIGS. 1 to 4 illustrate the structural configuration of the present invention, and FIG. 5 to 9 depict schematic views of continuous motion. The present invention provides a speed-control knife structure with straight in-and-out motion, which includes: a housing 1 in a rectangular cuboid shape, wherein the housing 1 has an internal space 11 in an interior thereof, a cutout 12 on an end face thereof and a blade exit 13 on a side thereof, and the internal space 11 communicates with the cutout 12 and the blade exit 13; an inner blade holder 2 installed in the internal space 11, wherein the inner blade holder 2 has both ends assembled to the housing 1 and is provided with a track hole 21 extending from a top end to a bottom end of the inner blade holder 2, and two connection plates 22 vertically protrude from the both ends of the inner blade holder 2 and are assembled with the housing 1; an upper guide plate 3 installed in the internal space 11 and spaced from the track hole 21 of the inner blade holder 2, wherein the upper guide plate 3 is cut with a slide channel 31 that corresponds to and communicates with the cutout 12 and includes a control part 32 that corresponds to the cutout 12 and partially extends out of the cutout 12 and becomes exposed from the housing 1 for user pressing control; a knife assembly 4 including a blade 41 and a sliding block 42, wherein (i) a part of the sliding block 42 is slidably disposed in the track hole 21, while another part of the sliding block 42 protrudes out of the track hole 21 toward the upper guide plate 3, (ii) the blade 41 is disposed on one side of the inner blade holder 2 and opposite to the protruding part of the sliding block 42, (iii) the blade 41 has one end assembled to the sliding block 42 and the other end facing the blade exit 13, and (iv) the sliding block 42 is movable along the profile of the track hole 21 to drive operable extension and retraction of the blade 41 through the blade exit 13; a push control member 5 having a part disposed in the internal space 11 and another part protruding from the housing 1, wherein (i) the push control member 5 is located between the upper guide plate 3 and the sliding block 42 and superimposed over the sliding block 42, allowing an axle pin 51 to penetrate through the blade 41, the sliding block 42 and the push control member 5, and when the upper guide plate 3 moves toward the blade exit 13, it contacts the part of the push control member 5 protruding from the housing 1 during the movement, indirectly driving movement of the sliding block 42 along the track hole 21, thus allowing the blade 41 to extend through the blade exit 13; two push blocks 6 in L-shaped sheet form, each detachably interlocked to the upper guide plate 3 and located between both ends of the slide channel 31 and having a part interlocked within the slide channel 31 and another part protruding downward from the upper guide plate 3 into a gap between the upper guide plate 3 and the inner blade holder 2, wherein an elastic member 61 is installed within the slide channel 31 and has both ends hooked onto the two push blocks 6, respectively, and provides elastic force to pull the two push blocks 6 toward each other; and a trigger clip 7 disposed between the sliding block 42 and the upper guide plate 3 and superimposed over the sliding block 42, allowing an axle rod 71 to penetrate through the blade 41, the sliding block 42 and the trigger clip 7 (in the present invention, each of the axle pin 51 and the axle rod 71 is three-part component which includes a sleeve, a screw and a nut, but is not limited thereto), wherein the trigger clip 7 is configured to pivot relative to the axle rod 71 and has a part interlocked to an end of the track hole 21 when the blade 41 has not yet moved toward the blade exit 13. In operation, the control part 32 drives the upper guide plate 3 to move toward the blade exit 13, pushing the push block 6 near the blade exit 13 and the push control member 5 by the upper guide plate 3. When the push block 6 is pushed and moved, the elastic member 61 is pulled, which generates elastic force. Simultaneously, the push control member 5 is pushed and thus indirectly drives the blade 41 to move. At this point, the trigger clip 7 disengages from the track hole 21 and pivots. The elastic force of the elastic member 61 then instantly pulls the push block 6 located far from the blade exit 13 to allow the push block 6 to push the sliding block 42, thereby the blade 41 quickly protruding from the blade exit 13.

Based on the above description and referring to FIGS. 5 to 9, the continuous actions transitioning from the retraction state to the extension state of the blade are illustrated. To deploy the blade, the user simply needs to place fingers on the control part 32 and apply force to push it, causing the control part 32 to move along the profile of the cutout 12. The movement of the control part 32 controls the upper guide plate 3 to move toward the blade exit 13. As the upper guide plate 3 moves, it simultaneously pushes the push block 6 located near the blade exit 13 to move as well. This movement of the push block 6 also pulls the elastic member 61, stretching it elastically. And, the end of the upper guide plate 3 that is farthest from the blade exit 13 gradually approaches and presses against the part of the push control member 5 that is exposed from the housing 1. With the continued movement of the upper guide plate 3, the trigger clip 7 located between the upper guide plate 3 and the sliding block 42 gradually pivots, disengaging from the track hole 21. At this point, the elastic force of the elastic member 61 has built up to a certain level. Once the trigger clip 7 completely disengages from the track hole 21, the push block 6 near the trigger clip 7 is pulled and moved by the elastic member 61, causing it to instantly impact and push the trigger clip 7. Since the trigger clip 7 is connected to the sliding block 42, the blade 41 of the knife assembly 4 will instantly extend from the blade exit 13 with the combined force of the user's push and the elastic force from the elastic member 61. If intending to reveal the intent to deploy the blade, the user can apply force to the control part 32. As long as the user continues to apply force to the control part 32, controlling whether the blade is deployed, the blade 41 of the knife assembly 4 will not instantly spring out. This allows the user to remain in a defensive stance or to observe whether the holder has the intention to deploy the blade before taking defensive action.

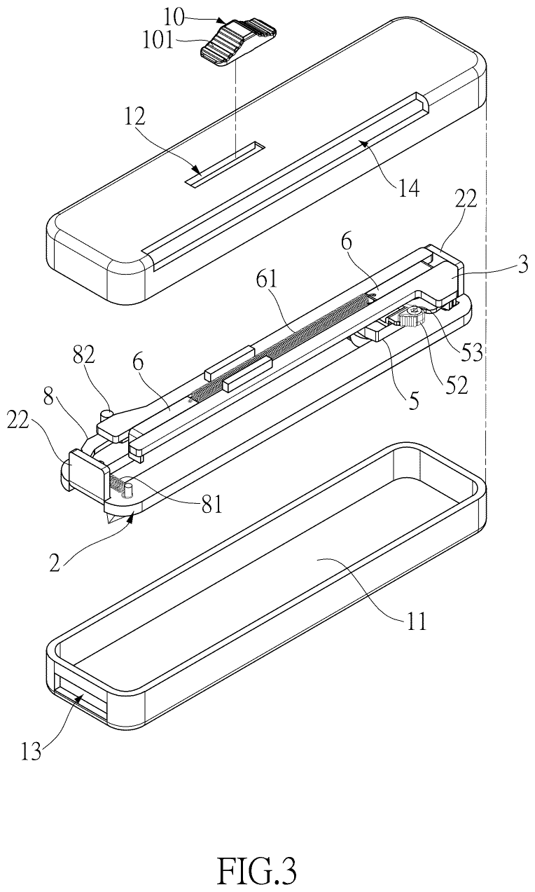

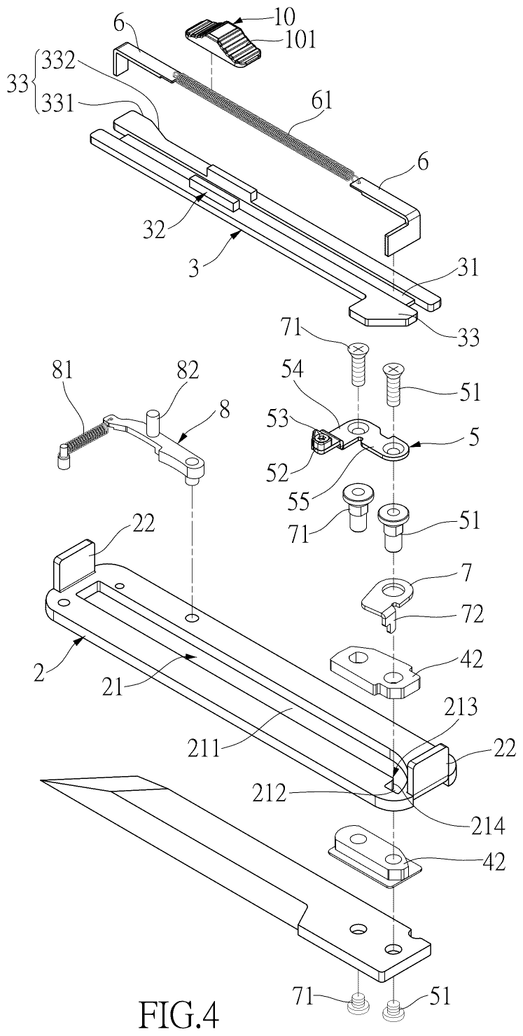

In addition to the primary technical illustration of the present invention, further details on other technical features and structures are described below. First, please refer to FIGS. 3 and 4. To prevent the blade 41 from retracting into the internal space 11 during use, which could create a hazard, a positioning arm 8 is pivotally mounted on the inner blade holder 2 and located near the blade exit 13. The positioning arm 8 is situated between the inner blade holder 2 and the upper guide plate 3. Additionally, one end of a spring 81 is hooked to the end of the positioning arm 8 near the blade exit 13, while the other end of the spring 81 is sleeved around a post block 111 within the internal space 11. The position of the post block 111 corresponds to the positioning arm 8. As the control part 32 drives the upper guide plate 3 to move toward the blade exit 13, the upper guide plate 3 pushes against the positioning arm 8 to cause pivot motion of the positioning arm 8 and stretch the spring 81, creating stored tension. Once the blade 41 extends out from the blade exit 13, the spring 81 releases its stored elastic force to press the positioning arm 8 against the sliding block 42 of the knife assembly 4. This mechanism can secure the blade 41, preventing it from retracting.

Continuing from the previous description and referring to FIGS. 5 through 9, the continuous actions are illustrated. The interaction between the upper guide plate 3 and the positioning arm 8 mainly utilizes an actuating rod 82 disposed on the positioning arm 8. The upper guide plate 3 features two actuating blocks 33 protruding from its ends. These actuating blocks 33 extend in opposite directions and have a trapezoidal shape. One actuating block 33 is designed to push against the part of the push control member 5 that protrudes from the housing 1, and the other actuating block 33 corresponds to the location where the positioning arm 8 is situated. The actuating block 33 near the positioning arm 8 has a tilted guiding surface 331 and a flat pushing surface 332. The flat pushing surface 332 and the side surface of the upper guide plate 3 are located at different heights. As the upper guide plate 3 moves, the actuating block 82 movably abuts against the flat pushing surface 332, the tilted guiding surface 331, and the peripheral surface of the upper guide plate 3. When the upper guide plate 3 is stationary, the actuating block 82 rests against the flat pushing surface 332, and the spring 81 is stretched. As the upper guide plate 3 begins to move toward the blade exit 13, the actuating block 82 slides down the tilted guiding surface 331 and shifts to the peripheral surface of the upper guide plate 3. Due to the height difference between the flat pushing surface 332 and the peripheral surface of the upper guide plate 3, the spring 81 releases its stored energy. With the continuous movement of the upper guide plate 3, after the blade 41 of the knife assembly 4 has extended out instantly, the sliding block 42, under movement, pushes against the positioning arm 8, causing it to pivot and engage with the peripheral surface of the sliding block 42. As such, the position of the blade 41 can be maintained after it is extended, preventing the blade 41 from retracting on its own during use.

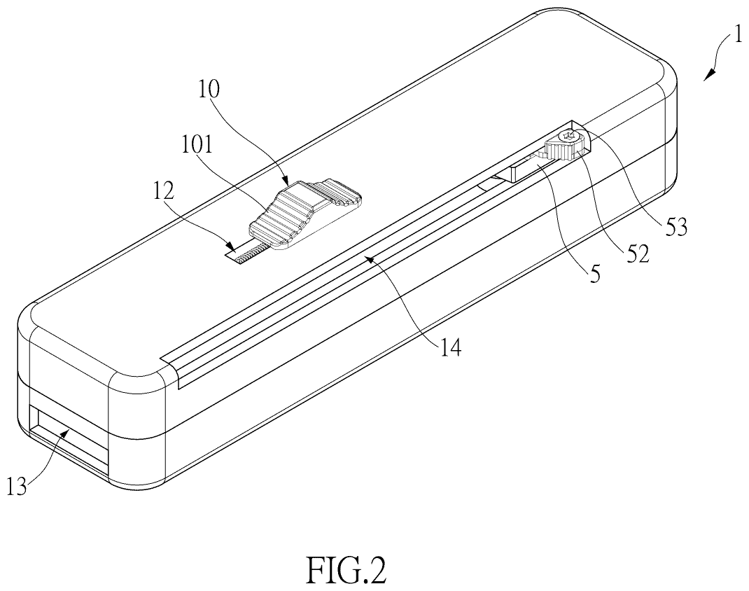

Continuing with the illustration and referring to FIGS. 2 through 4, the mechanism for controlling the speed of the blade extension is explained. For the additional function of the present invention for controlling the speed of blade extension, the housing 1 is further cut with a lateral slide slot 14 that corresponds to the protruding position of the push control member 5. The lateral slide slot 14 communicates with the internal space 11. One end of the push control member 5 extends through the lateral slide slot 14 and is exposed outside the housing 1. This allows the protruding part of the push control member 5 to move along the profile of the lateral slide slot 14. Additionally, a regulating block 52 is installed on the end of the push control member 5 that protrudes from the housing 1 and is secured to the push control member 5 by a screw 53. The screw 53 penetrates through the push control member 5 and movably abuts against the housing 1. When the screw 53 is loosened relative to the push control member 5, the contact with the housing 1 is reduced, thereby lowering friction and allowing the blade assembly 4 to extend quickly through the blade exit 13. Conversely, when the screw 53 is tightened relative to the push control member 5, the contact with the housing 1 is increased, thereby raising friction and reducing the speed at which the blade 41 of the blade assembly 4 extends.

The illustration above regarding the relationship between the trigger clip 7 and the track hole 21 primarily addresses the prevention of the blade 41 from inadvertently deploying and causing danger. The detailed technical features are as follows. The track hole 21 further includes a straight section 211 and a curved locking section 212. As shown in FIGS. 3 and 4, the curved locking section 212 is connected to the straight section 211, forming a locking protrusion 213 at a junction. The locking protrusion 213 has a curved guiding surface 214. The trigger clip 7 has a blocking portion 72 that corresponds to the curved locking section 212 of the track hole 21. When the blade assembly 4 is not yet moved, the blocking portion 72 rests against the locking protrusion 213. As the upper guide plate 3 pushes the push control member 5 to move, the blocking portion 72 of the trigger clip 7 is guided along the curved guiding surface 214 of the locking protrusion 213, allowing the trigger clip 7 to pivot around the axis rod 71. Once the blocking portion 72 disengages from the locking protrusion 213, the sliding block 42 can move along the straight section 211 and push the blade 41 out through the blade exit 13. Conversely, after the blade is retracted, the blocking portion 72 of the trigger clip 7 will engage with the wall surface of the curved locking section 212. Only when the user applies force to indirectly push the upper guide plate 3, the blocking portion 72 will move along the curved guiding surface 214 back to the curved locking section 212 and lock in place.

As shown in FIGS. 3 and 4, to ensure that the blade 41 of the blade assembly 4 is deployed at a more stable speed, the push control member 5 is designed to include a first section 54 and a second section 55 between the upper guide plate 3 and the sliding block 42. The first section 54 has one end connected to the second section 55, forming an L-shape, and the other end protruding from the housing 1 and bending upward. The axis rod 71 and the axis pin 51 penetrate through both the first section 54 and the second section 55 of the push control member 5. This setup ensures a secure connection between the push control member 5 and the sliding block 42, allowing the push control member 5 to be stably driven by the upper guide plate 3 during movement.

To ensure stable control of the blade deployment, a control member 10 is further assembled to the part of the control part 32 that protrudes through the cutout 12. The control member 10 is shaped like a cone with a flat top. Both sides of the flat top of the control member 10 are provided with textured patterns 101 to enhance friction for the user's fingers during pressing operations, resulting in stable and precise manipulation of the control member 10. This design allows users to adjust the force applied and the timing of the release according to their needs and blade deployment intentions, as shown in FIG. 1.

What is claimed is:

1. A speed-control knife structure with straight in-and-out motion, comprising:
a housing, having an internal space in an interior thereof, a cutout on an end face of the housing and a blade exit on a side of the housing, wherein the internal space communicates with the cutout and the blade exit;
an inner blade holder, installed in the internal space, wherein the inner blade holder has both ends assembled to the housing and is provided with a track hole extending from a top end to a bottom end of the inner blade holder;
an upper guide plate, installed in the internal space and spaced from the track hole of the inner blade holder, wherein the upper guide plate is cut with a slide channel that corresponds to and communicates with the cutout and includes a control part that corresponds to the cutout and partially extends out of the cutout and becomes exposed from the housing;
a knife assembly, including a blade and a sliding block, wherein (i) a part of the sliding block is slidably disposed in the track hole, while another part of the sliding block protrudes out of the track hole toward the upper guide plate, (ii) the blade is disposed on one side of the inner blade holder and opposite to the part of the sliding block that protrudes, (iii) the blade has one end assembled to the sliding block and the other end facing the blade exit, and (iv) the sliding block is movable along a profile of the track hole to drive operable extension and retraction of the blade through the blade exit;
a push control member, having a part disposed in the internal space and another part protruding from the housing, wherein the push control member is located between the upper guide plate and the sliding block, allowing an axle pin to penetrate through the blade, the sliding block and the push control member, and when the upper guide plate moves toward the blade exit, the upper guide plate contacts the part of the push control member protruding from the housing during the movement, indirectly driving movement of the sliding block along the track hole;
two push blocks, each detachably interlocked to the upper guide plate, located between both ends of the slide channel, and having a part interlocked within the slide channel and another part protruding downward from the upper guide plate into a gap between the upper guide plate and the inner blade holder, wherein an elastic member is installed within the slide channel and has both ends hooked onto the two push blocks, respectively; and
a trigger clip, disposed between the sliding block and the upper guide plate, allowing an axle rod to penetrate through the blade, the sliding block and the trigger clip, wherein the trigger clip is configured to pivot relative to the axle rod and has a part interlocked to an end of the track hole when the blade has not yet moved toward the blade exit;
wherein the control part is configured to drive the upper guide plate to move toward the blade exit, pushing the push block near the blade exit and the push control member by the upper guide plate; when the push block is pushed and moved, the elastic member is pulled, which generates elastic force, and simultaneously, the push control member is pushed and thus indirectly drives the blade to move and the trigger clip disengages from the track hole and pivots; and the elastic force of the elastic member then instantly pulls the push block located far from the blade exit to allow the push block to push the sliding block, thereby the blade quickly protruding from the blade exit.

2. The speed-control knife structure with straight in-and-out motion as claimed in claim 1, further comprising a positioning arm pivotally mounted on the inner blade holder and located near the blade exit, wherein the positioning arm is situated between the inner blade holder and the upper guide plate; one end of a spring is hooked to an end of the positioning arm near the blade exit, while the other end of the spring is sleeved around a post block within the internal space; as the control part drives the upper guide plate to move toward the blade exit, the upper guide plate pushes against the positioning arm to cause pivot motion of the positioning arm and stretch the spring, creating stored tension; once the blade extends out from the blade exit, the spring releases the stored tension to press the positioning arm against the sliding block of the knife assembly, thereby securing and preventing the blade from retraction.

3. The speed-control knife structure with straight in-and-out motion as claimed in claim 1, wherein the housing is further cut with a lateral slide slot that corresponds to the part of the push control member that protrudes; one end of the push control member extends through the lateral slide slot and is exposed outside the housing; a regulating block is installed on the end of the push control member that protrudes from the housing and is secured to the push control member by a screw that penetrates through the push control member and movably abuts against the housing; when the screw is loosened relative to the push control member, reducing contact with the housing and thereby lowering friction, the blade assembly is allowed to extend quickly through the blade exit. ; and conversely, when the screw is tightened relative to the push control member, increasing contact with the housing and thereby raising friction, the blade of the blade assembly experiences a reduced deployment speed.

4. The speed-control knife structure with straight in-and-out motion as claimed in claim 1, wherein the track hole further includes a straight section and a curved locking section; the curved locking section is connected to the straight section, forming a locking protrusion at a junction; the locking protrusion has a curved guiding surface; the trigger clip has a blocking portion that corresponds to the curved locking section of the track hole; when the blade assembly is not yet moved, the blocking portion rests against the locking protrusion; as the upper guide plate pushes the push control member to move, the blocking portion of the trigger clip is guided along the curved guiding surface of the locking protrusion, allowing the trigger clip to pivot around the axis rod; and once the blocking portion disengages from the locking protrusion, the sliding block is allowed to move along the straight section and drive the blade out through the blade exit.

5. The speed-control knife structure with straight in-and-out motion as claimed in claim 1, wherein the push control member further includes a first section and a second section between the upper guide plate and the sliding block; the first section has one end connected to the second section, forming an L-shape, and the other end protruding from the housing; and the axis rod and the axis pin penetrate through both the first section and the second section of the push control member.

6. The speed-control knife structure with straight in-and-out motion as claimed in claim 2, wherein the upper guide plate is further provided with two actuating blocks protruding from both ends thereof, respectively; the actuating blocks extend in opposite directions; one of the actuating block is configured to push against the part of the push control member that protrudes from the housing, and the other one of the actuating block corresponds to a location where the positioning arm is situated; the actuating block near the positioning arm has a tilted guiding surface and a flat pushing surface; the flat pushing surface and a side surface of the upper guide plate are located at different heights; the positioning arm is equipped with an actuating rod that protrudes and corresponds to the actuating block located near the positioning arm; when the upper guide plate moves, the actuating block movably abuts against the flat pushing surface, the tilted guiding surface, and a peripheral surface of the upper guide plate; when the upper guide plate moves toward the blade exit, the actuating block first abuts against the flat pushing surface, stretching the spring, and then slides down the tilted guiding surface and shifts to the peripheral surface of the upper guide plate, releasing elastic force of the spring; and after the blade of the knife assembly has extended out instantly, the sliding block, under movement, pushes against the positioning arm, causing the positioning arm to pivot and engage with the peripheral surface of the sliding block.

7. The speed-control knife structure with straight in-and-out motion as claimed in claim 1, further comprising a control member assembled to the part of the control part that protrudes through the cutout, and a top surface of the control member has a textured pattern that enhances stability during push operations of the control member.
